(19) United States
(12) Patent Application Publication
(10) Pub. No.: US 2009/0326855 A1
(43) Pub. Date: Dec. 31, 2009

(54) ELECTRICAL OUTLET

(75) Inventor: MICHAEL BARTONEK, Wien (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: Moeller Gebaudeautomation GmbH, Schrems (AT)

(21) Appl. No.: 12/490,786

(22) Filed: Jun. 24, 2009

Related U.S. Application Data
(60) Provisional application No. 61/075,454, filed on Jun. 25, 2008.

(30) Foreign Application Priority Data
Jun. 25, 2008 (AT) A 1015/2008

(51) Int. Cl. G01M 19/00; G06F 17/30; H02H 3/00

(52) U.S. Cl. 702/122; 707/10; 707/E17.01; 361/88

(57) ABSTRACT

To simplify testing of an electrical distribution and/or installation facility, an electrical outlet installed in the electrical distribution and/or installation facility includes an element or a unit for contactless storage of data that include information characteristic for the electrical distribution and/or installation facility. The element or unit may include a writable memory with, for example, a radio or RFID transponder.

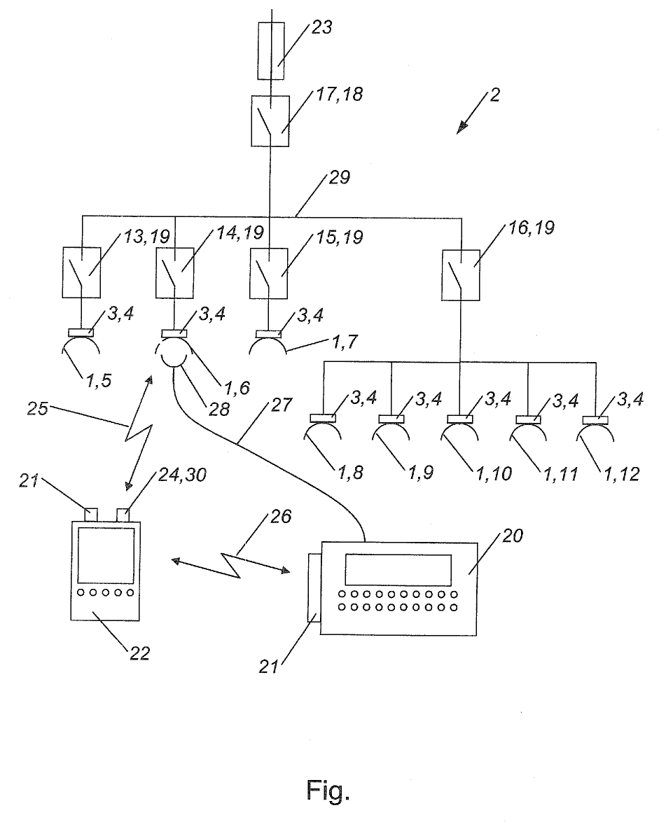

### CROSS-REFERENCES TO RELATED APPLICATIONS

This application claims the benefit of prior filed U.S. provisional Application No. 61/075,454, filed Jun. 25, 2008, pursuant to 35 U.S.C. 119(e), the content of which is incorporated herein by reference in its entirety as if fully set forth herein

This application also claims the priority of Austrian Patent Application, Ser. No. A 1015/2008, filed Jun. 25, 2008, pursuant to 35 U.S.C. 119(a)-(d),

### BACKGROUND OF THE INVENTION

The present invention relates to an electrical outlet, and more particularly to an electrical outlet for an electrical distribution and/or installation facility.

The following discussion of related art is provided to assist the reader in understanding the advantages of the invention, and is not to be construed as an admission that this related art is prior art to this invention.

It is known to provide electrical outlets in electrical distribution and/or installation facilities for connecting an electrical device or a load to the electrical distribution and/or installation facility. Applicable guidelines, such as the VDE or ÖVE guidelines, require electrical distribution and/or installation facilities to be equipped with specific protective apparatus, such as circuit breakers, particularly ground-fault interrupters and/or line circuit breakers. In the event of an electrical fault within the electrical distribution and/or installation facility, these circuit breakers are to shut down at least a part of the electrical distribution and/or installation facility, in order to avoid harming people and/or damaging facilities due to the effect from the electrical current.

So-called installation testers and/or installation test devices are conventionally used to ensure the proper function of the electrical distribution and/or installation facility, in particular the circuit breakers. The type of the distribution and/or installation facility is to inputted, in particular the type of the installed circuit breaker and/or its characteristic data, such as its rated fault current, etc. Individual circuits of the electrical distribution and/or installation facility must be identified before performing the test, and the assignment of a circuit breaker to an electrical outlet must be determined. The installation tester is connected to an electrical outlet of the distribution and/or installation facility to be tested and simulates a faulty device, whereby the characteristic values upon shutdown of the electrical distribution and/or installation facility are measured, for example, the fault current value at which the affected circuit breaker triggered, and the trigger time. Testing of the electrical distribution and/or installation facility is typically documented by a test log, which includes the measurement results and/or test results.

Disadvantageously, assigning the individual electrical outlets to the individual circuit breakers is cumbersome and complex, and errors are likely to occur during this activity. Furthermore, the corresponding data must be inputted manually into the installation tester, which also requires significant effort and is prone to errors.

It would therefore be desirable and advantageous to provide an improved electrical outlet in a distribution and/or installation facility to obviate prior art shortcomings and to simplify testing of the electrical distribution and/or installation facilities.

### SUMMARY OF THE INVENTION

According to one aspect of the present invention, an electrical outlet for an electrical distribution and/or installation facility includes a storage element for contactless storage of data having information characteristic of the electrical distribution and/or installation facility.

According to another aspect of the invention, an electrical distribution and/or installation facility includes at least one electrical outlet with a storage element for contactless storage of data having information characteristic of the electrical distribution and/or installation facility, and at least one circuit breaker.

According to yet another aspect of the invention, an installation test device for testing an electrical distribution and/or installation facility with an electrical outlet and a circuit breaker includes at least one data interface configured for wireless input of data, wherein the data include information characteristic of the electrical distribution and/or installation facility.

According to still another aspect of the invention, a method for testing an electrical distribution and/or installation system, with at least one electrical outlet and at least one circuit breaker, includes the steps of wirelessly reading from a memory associated with the electrical outlet data that include information characteristic of the electrical distribution and/or installation facility, transmitting the read data at least indirectly to an installation test device, preparing a test profile for testing the electrical distribution and/or installation facility, testing the electrical distribution and/or installation facility by using the installation test device with the test profile, and outputting at least one test result.

Embodiments of the invention may include one or more of the following features, either separately or in combination. The storage element may include a memory, such as a writable radio transponder or RFID transponder. The data interface of the installation test device may be implemented as an at least half-duplex-capable radio interface, for example, a Bluetooth interface. The installation test device may further include an RFID read/write unit. The circuit breaker may be implemented as a ground-fault interrupter and/or a line circuit breaker.

The test result may be wirelessly transmitted to a computer, with the data being wirelessly read with an RFID reader.

Testing of electrical distribution and/or installation facilities can thus be significantly simplified, because an electrical distribution and/or installation facility can be tested by only reading the data from the memory of an electrical outlet and transmitting individual parameters to an installation test device without additional manual input. The cumbersome assignment of an electrical outlet to a circuit breaker and the manual input of the parameters required for the test into the installation test device can thus be eliminated. The safety of an electrical distribution and/or installation facility may thus also be enhanced, because the most frequent error sources encountered during testing of the electrical distribution and/or installation facility are eliminated.

### BRIEF DESCRIPTION OF THE DRAWING

Other features and advantages of the present invention will be more readily apparent upon reading the following description of currently preferred exemplified embodiments of the invention with reference to the accompanying drawing, in which the sole FIGURE shows a block diagram of an exemplary embodiment of an electrical distribution and/or installation facility according to the invention.

### DETAILED DESCRIPTION OF PREFERRED EMBODIMENTS

The depicted embodiment is to be understood as illustrative of the invention and not as limiting in any way. It should also be understood that the FIGURE is not necessarily to scale. In certain instances, details which are not necessary for an understanding of the present invention or which render other details difficult to perceive may have been omitted.

Turning now to the FIGURE, there is shown an electrical distribution and/or installation facility 2 having a pre-determinable number of electrical outlets 1 according to the invention, and an installation test device 20 according to the invention.

Testing of electrical distribution and/or installation facilities 2 may be significantly simplified, because a test of an electrical distribution and/or installation facility 2 can be performed by only reading the data from the memory of an electrical outlet 1 and transmitting individual parameters to an installation test device 20 without further manual input. The cumbersome assignment of an electrical outlet 1 to a circuit breaker 13, 14, 15, 16, 17 and the manual input of the parameters required for the test into the installation test device 20 may thus also be eliminated. The safety of an electrical distribution and/or installation facility 2 may thus be enhanced, because the most frequent error sources encountered during testing of the electrical distribution and/or installation facility 2 are eliminated.

An electrical distribution and/or installation facility 2 is a facility for providing and distributing electrical power, and includes at least one electrical outlet 1, 5 for connecting at least one electrical load. The electrical outlet 1 can be of any type as long as it is able to deliver the desired electrical current. Preferably, the electrical outlets are so-called ground-fault-protected outlets and/or Schuko outlets. Furthermore, at least one circuit breaker 13 is provided for shutting down a part of the electrical distribution and/or installation facility 2 in the event of a fault, in particular an electrical fault. The least one circuit breaker 13 can be implemented as a ground-fault interrupter 18, a line circuit breaker, a power switch, and/or as a combination of such circuit breakers. Preferably, so-called combination switches 19, i.e., a combination of a ground-fault interrupter 18 and a line circuit breaker, may be used. The individual assemblies of an electrical distribution and/or installation facility 2 are connected to one another with electric power cables 29. The electrical distribution and/or installation facility 2 has at least one current-conducting phase, also referred to a phase conductor, and a neutral conductor; however, multiple, for example, three phase conductors and optionally a ground wire may also be employed, for example, in a conventional three-phase network.

The single FIGURE shows an exemplary electrical distribution and/or installation facility 2 with a total of eight electrical outlets 1, 5, 6, 7, 8, 9, 10, 11, 12. The first, second, and third electrical outlet 1, 5, 6, 7 are each protected by a separate first, second, or third circuit breaker 13, 14, 15, respectively, which are each implemented as a combination switch 19. The additional fourth, fifth, sixth, seventh, and eighth electrical outlets 1, 8, 9, 10, 11, 12 are protected together by a single, fourth circuit breaker 16 implemented as a combination switch 19. The parts of the electrical distribution and/or installation facility 2 secured by the first, second, third, and fourth circuit breaker 13, 14, 15, 16 are also secured by a fifth circuit breaker 17, implemented as a ground-fault interrupter 18, and a safety fuse 23.

According to the invention, the electrical outlet 1 includes means for contactless storage of data comprising information concerning the electrical distribution and/or installation facility, these means allowing contactless storage and preferably also read-out of the data. The means may be optical markings, for example a so-called barcode. Preferably, the means may include at least one memory, the memory preferably including at least one electrical memory element, such as a flip-flop. The memory is not shown separately in the single FIGURE, but rather is an integral component of the radio transponder 3, and is therefore not indicated with a reference symbol.

The data which have information concerning the electrical distribution and/or installation facility 2 may indicate the type of the distribution and/or installation facility 2, the type of the circuit breaker(s) 13, 17, which protect the electrical outlet 1, 5. Rated fault currents, characteristics, sensitivity, trigger limit values, and trigger limit times can be part of the data. Furthermore, the data may contain information about the circuit diagram and about additional components within the electrical distribution and/or installation facility 2. The data confer a unique assignment of an electrical outlet 1, 5, 6, 7, 8, 9, 10, 11, 12 to a specific circuit breaker 13, 14, 15, 16, 17.

The data are written in the memory during or after the installation of the electrical distribution and/or installation facility using a corresponding write unit, such as a computer 22 having a corresponding interface, such as an RFID writer 30.

According to a particularly advantageous embodiment of the present invention, the electrical outlet 1 has a writable radio transponder 3. An optical data interface may also be provided, such as an infrared interface. A radio transponder 3 is preferably a configuration constructed of a radio transmitter and a radio receiver. The radio transponder 3 may be half-duplex-capable or full-duplex-capable, wherein the radio transponder 3 may operate according to any predetermined radio transmission method and/or a messaging protocol. Preferably, the radio transponder 3 may be implemented as an RFID (Radio Frequency IDentification) transponder 4 which is increasingly used for contactless data transmission. Any RFID method may be applied and/or any type of an RFID transponder 4 may be employed. Both active and passive RFID transponders 4 may be used; if active RFID transponders 4 are used, a power supply unit connected to the network line 29 may be provided for supplying power to the RFID transponder 4.

The memory is associated with the radio transponder 3, therefore the content of the memory is writable by the radio transponder 3 and may also be read out thereby, whereby data may be stored on the memory, and the data may be read out of the memory and transmitted using radio. Passive RFID transponders 4 are preferably provided. They have a sufficiently long-range transmission distance and a sufficient storage capacity, and also have a low overall height and a low price.

The radio transponders 3, i.e., preferably the RFID transponders 4, are located in the area of the electrical outlet 1, preferably concealed from the user behind a cover of the electrical outlet 1, such as a cover frame. A passive RFID transponder 4 can advantageously be located in a housing wall of the electrical outlet 1, for example, embedded when the electrical outlet 1 is manufactured by plastic injection molding. The RFID transponder 4 can then not become separated from the electrical outlet 1, preventing the RFID transponder 4 to be inadvertently omitted on the electrical outlet 1.

Electrical distribution and/or installation facilities 2 are tested with an installation test device 20 to ascertain that they meet relevant protection guidelines in electrical facilities, as stipulated by the Austrian ÖVE/ÖNORM E 8001, the German DIN VDE 0100, or the international IEC 60364. For example, trigger current, contact voltage, trigger time, loop/ground impedance, short-circuit current, ground resistance, line resistance and/or isolation resistance are measured, and/or the electrical distribution and/or installation facility is tested to ascertain that it satisfies the limit values for the particular parameters. The installation test device 20 has a plug 28 compatible with at least one electrical outlet 1, 5, 6, 7, 8, 9, 10, 11, 12, and is connected with the plug 28 - via a measuring line 27 - to an electrical outlet 1, 5, 6, 7, 8, 9, 10, 11, 12, such as the illustrated second electrical outlet 1, 6, for connection to the electrical distribution and/or installation facility 5. Test signals, such as test currents, are supplied via the plug 28 to the electrical distribution and/or installation facility 2, and the effect of these test signals on the electrical distribution and/or installation system 2 is measured, for example the effect on the second and fifth circuit breakers 14, 17.

Furthermore, the invention relates to an installation test device 20 for testing an electrical distribution and/or installation facility 2 with at least one electrical outlet 5 and one circuit breaker 13. The installation test device 20 has at least one data interface 21, with the data interface 21 being implemented for the wireless input of data having information concerning the electrical distribution and/or installation facility 2, thereby achieving the aforedescribed advantages.

Advantageously, the data interface 21 is implemented as an at least half-duplex-capable radio interface. Thus, the data may be inputted, and test results, measurement data and/or test logs may also be output. The data interface 21 may be implemented according to a predetermined radio transmission protocol and/or messaging protocol. In a particularly advantageous embodiment of the invention shown in the single FIGURE, the data interface 21 is implemented as a Bluetooth interface. According to this embodiment variant, the data are read out from the memory of the electrical outlet 1, 5, 6, 7, 8, 9, 10, 11, 12 using a computer 22, which may be implemented as a PDA (Personal Data Assistant) or as a laptop computer, and which has and/or interacts with an RFID reader 24 as well as preferably also an RFID writer 30. The data are then transmitted to the installation test device 20 using a data interface 21. The RFID reader 24 and the RFID writer 30 are implemented for data exchange with an RFID transponder 4, which is located in the electrical outlet 1, 5, 6, 7, 8, 9, 10, 11, 12, and employ corresponding transmission protocols. The test results may be transmitted after the test via the data interface 21 back to the computer 22. A simple and cleanly logged documentation of the performed tests is thus possible.

According to a modified embodiment of the present invention, the installation test device 20 may include an RFID reader 24 and/or writer 30, with the data being read directly from the memory. Moreover, the installation test device 20 may also include an internal memory and/or a printing interface.

The invention is also directed to a method for testing a electrical distribution and/or installation facility 2, with at least one electrical outlet 5 and at least one circuit breaker 13, in particular a ground-fault interrupter 18 and/or a line circuit breaker. Data, which include information concerning the electrical distribution and/or installation facility, are automatically read out wirelessly from a memory associated with the electrical outlet 5 and transmitted at least indirectly to an installation test device 20. Subsequently, a test profile for testing the electrical distribution and/or installation facility 2 is prepared, and the electrical distribution and/or installation facility 2 is then tested using the test profile in the installation test device 20. At least one test result is outputted, thereby attaining the aforedescribed advantages.

The data are read from the memory of the particular electrical outlet 1, 5, 6, 7, 8, 9, 10, 11, 12 with a computer 22 and stored in the computer 22. Preferably, the data are stored in a memory of an RFID transponder 4, and are read out using a corresponding RFID reader 24. The corresponding RFID transmission link is shown in the single FIGURE by the double arrow 25. According to this embodiment, the computer 22 transmits the data via the data interface 21, which is preferably implemented as a Bluetooth interface, to the installation test device 20. The corresponding data transmission link is illustrated in the single FIGURE by the double arrow 26. Based on these data, the installation test device 20, which is connected to the second electrical outlet 1, 6 with plug 28, performs a test of the electrical distribution and/or installation facility 2, in particular of the second and fifth circuit breaker 14, 17, and prepares a test result, which is preferably wirelessly transmitted to the computer 22.

Preferably, the test results are stored in the computer 22 together with a map of the tested electrical distribution and/or installation facility 2. If tests are performed repeatedly, it can be determined whether the trigger parameters in the individual circuit breakers 13, 14, 15, 16, 17 change, and these circuit breakers 13, 14, 15, 16, 17 may then subsequently be intentionally tested at predetermined time intervals.

Additional embodiments according to the invention may only include part of the described features, or may include the described features in combination.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An electrical outlet for an electrical distribution and/or installation facility, comprising a storage element for contactless storage of data having information characteristic of the electrical distribution and/or installation facility.

2. The electrical outlet of claim 1, wherein the storage element comprises at least one memory.

3. The electrical outlet of claim 2, wherein the at least one memory includes a writable radio transponder.

4. The electrical outlet of claim 3, wherein the writable radio transponder includes an RFID transponder.

5. An electrical distribution and/or installation facility comprising:
at least one electrical outlet comprising a storage element for contactless storage of data having information characteristic of the electrical distribution and/or installation facility, and at least one circuit breaker.

6. The electrical distribution and/or installation facility of claim 5, wherein the storage element comprises at least one memory.

7. The electrical distribution and/or installation facility of claim 6, wherein the at least one memory includes a writable radio transponder.

8. The electrical distribution and/or installation facility of claim 7, wherein the writable radio transponder includes a writable RFID transponder.

9. An installation test device for testing an electrical distribution and/or installation facility with at least one electrical outlet and a circuit breaker, comprising
at least one data interface configured for wireless input of data, wherein the data include information characteristic of the electrical distribution and/or installation facility.

10. The installation test device of claim 9, wherein the data interface is implemented as an at least half-duplex-capable radio interface.

11. The installation test device of claim 10, wherein the radio interface is a Bluetooth interface.

12. The installation test device of claim 9, further comprising an RFID read/write unit.

13. The device of claim 9, wherein the at least one circuit breaker comprises at least one of a ground-fault interrupter and a line circuit breaker.

14. A method for testing an electrical distribution and/or installation system with at least one electrical outlet and at least one circuit breaker, comprising the steps of:
wirelessly reading from a memory associated with the electrical outlet data that include information characteristic of the electrical distribution and/or installation facility,
transmitting the read data at least indirectly to an installation test device,
preparing a test profile for testing the electrical distribution and/or installation facility,
testing the electrical distribution and/or installation facility by using the installation test device with the test profile, and
outputting at least one test result.

15. The method of claim 14, wherein outputting the at least one test result includes the step of wirelessly transmitting the test result to a computer.

16. The device of claim 14, wherein wirelessly reading the data includes reading the data with an RFID reader.

17. The device of claim 14, wherein the at least one circuit breaker comprises at least one of a ground-fault interrupter and a line circuit breaker.
